(19) United States
(12) Patent Application Publication
(10) Pub. No.: US 2003/0028957 A1
(43) Pub. Date: Feb. 13, 2003

(54) Machine for removing clogged items in pipe and cleaning the pipe, method for cleaning pipe and member for prohibiting leakage of compressed air

(76) Inventor: Sakae Kawai, Nisiibaraki (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/212,263

(22) Filed: Aug. 6, 2002

(30) Foreign Application Priority Data
Aug. 8, 2001 (JP) 2001-275754
Apr. 10, 2002 (JP) 2002-143868

(51) Int. Cl. B08B 9/032; E03D 9/00

(52) U.S. Cl. 4/255.01; 15/3.5

(57) ABSTRACT

There can be provided a pipe clogged item removing and pipe cleaning device as well as its method in which the clogged items in various kinds of pipes can be removed rapidly, simply and easily and the pipes can be cleaned in a work such as a repairing work for the clogged state in a toilet stool, they can be used widely not only in the usual homes, but also in various kinds of drain facilities in the usual society, for example. In the case that the present invention is constituted as a toilet stool clogged state repairing instrument, for example, the instrument is comprised of the pressure tank, the compressor for use in supplying the compressed air into the tank, the air feeding pipe connected to the pressure tank through the opening or closing unit, the abutting member for air-tightly mounting the air feeding pipe at the drain port of the toilet stool, the water splashing prohibiting member, the mounting member, the transparent window (not shown), the slide hole (not shown) and a fixing tool constituted of the winged screw and the like.

### BACKGROUND OF THE INVENTION

1. Field of the Invention

This invention relates to a pipe clogged item removing and pipe cleaning machine or device for a pipe or the like and its method.

2. Related Background Art

In order to remove some clogged items in a drain pipe or the like at a sink and a toilet stool or the like in the usual homes, there has been widely carried out a method for flowing water in a pipe under application of a negative pressure generated by the extending or retracting action of the extremity end suction tool while the suction tool having a rubber cup-shaped suction element at its extremity end is being abutted against the drain port so as to move the clogged items and remove them.

For example, the Japanese Examined Utility Model Publication No. Hei 3-16940 has a proposal of a device for feeding air into a pipe under application of a pneumatic pump manually acted to push out the clogged items with the pneumatic pressure.

As described above, although the cup-shaped suction instrument was a convenient and low price unit applied for a use in usual homes, this type of instrument was not convenient in its efficient work and was accompanied with a troublesome work.

In addition, there occur many possibilities that the facility from which the clogged items in a pipe are to be removed is not only the pipe of home-use equipment such as a drain pipe in a sink and a toilet stool, but also the removing of the clogged items in the pipe installed at an agricultural pond or the like which can not be processed simply and easily.

### SUMMARY OF THE INVENTION

It is an object of the present invention to enable a pipe clogged item removing and pipe cleaning machine or device, and a pipe clogged item removing and pipe cleaning method to be attained which can be used not only in usual homes, but also used widely in various kinds of drain water facilities in general range of societies, which can remove the clogged items in various kinds of pipes rapidly, simply and easily and further the cleaning work can also be performed.

A constitution of the pipe clogged item removing and pipe cleaning machine or device of the present invention employed for accomplishing the aforesaid object is;

(1) characterized in that the same is comprised of a fixing member air-tightly installed at a pipe or the like requiring a removal of clogged items and cleaning inside of it, an air feeding pipe for supplying instantly air through the fixing member, and a pressure tank connected to the air feeding pipe through an opening or closing unit and having an air feeding port for supplying the compressed air and a pressure;

(2) characterized in that the pressure tank at (1) above has an air feeding port and/or a pressure gauge; or

(3) characterized in that the same is comprised of the fixing member air-tightly installed at a pipe or the like requiring removal of the clogged items and cleaning inside of it and an air feeding pipe for instantly supplying air through the fixing member, a pressure tank connected to the air feeding pipe through the opening or closing unit and having a pressure gauge, and a compressor for supplying compressed air into the pressure tank,

(4) characterized in that according to (1) or (2) or (3) above, the pipe requiring the removal of the clogged items and cleaning inside the pipe is a drain pipe for a toilet stool, the fixing member is a toilet stool clogged state repairing instrument having the air feeding pipe, a water splashing prohibiting member of a size to cover an upper edge of a toilet stool main body, an instrument fixing table positioned above the water splashing prohibiting member, having the air feeding pipe inserted therein, having a slide hole extending to enable its inclination in a forward or rearward direction to be adjustable and having a transparent window for use in observation for checking a positional relation between the hole of the toilet stool drainpipe and the air feeding pipe, a fitting member air-tightly fitted to the hole of the toilet stool drain pipe arranged at the extremity end of the air feeding pipe and a fixing member for fixing the air feeding pipe arranged on the instrument fixing table,

(5) characterized in that according to (1) or (2) or (3) the fixing instrument has a first abutting member constituted of a plate-like member of hard rubber sponge and a second abutting member constituted of soft spherical or its similar shaped sponge compression member fixed to the plate-like supporting member,

(6) characterized in that according to (1) or (2) or (3) the fixing member is comprised of a conical member of rubber resilient material, its bottom surface at a larger circle side has a large conical notch portion and it can be air-tightly fixed to an opening end of the pipe from the large circle side or from the small circle side,

(7) characterized in that according to (1) or (2) or (3) the fixing instrument is of a rod-like member constituted of rubber-like resilient material, is inserted into an end surface of the pipe, engaged with the pipe by a releasing prohibiting fitting and at the same time the rod-like member is closely brought into contact with the pipe through rotation of a nut threadably fixed to the air feeding pipe axially passing therethrough,

(8) characterized in that according to (3), the fixing instrument has a close fitting device air-tightly fixed to the air feeding pipe, capable of being bulged out or shrunk with pneumatic pressure, after being inserted into the pipe requiring removal of the clogged items and cleaning inside the pipe, and air-tightly fixing the air feeding pipe into the pipe and the like under a bulging-out action caused by supplying of air, and a flow passage for operating the close fitting device with the compressor.

In addition, the pipe cleaning method of the present invention is

(9) characterized in that air is supplied instantly under application of the pipe clogged item removing and pipe cleaning device of (3) under a state in which water is supplied after the sponge of substantially the same diameter as that of the inner diameter of the pipe is inserted into the pipe requiring the pipe clogged item removal and pipe inside cleaning, the clogged items in the pipe are removed and inside the pipe is cleaned through motion of the sponge.

Further, the compressed air leakage prohibiting member of the present invention is

(10) characterized in that in the case that the pipe or the like requiring removal of the clogged items and cleaning inside the pipe has a plurality of openings communicating to each other, the device is used in a pipe clogged item removing and pipe cleaning method in which the device is inserted into one or more openings except one opening, used for prohibiting leakage of the compressed air from the opening, an air feeding valve is arranged at one end by a rod-like bag constituted of a rubber-like resilient member, the device is inserted into a location requiring a passage shielding to feed air from the air feeding valve so as to shield the location, and

(11) characterized in that in the case that the pipe or the like requiring removal of the clogged items and cleaning inside the pipe has a plurality of openings communicating to each other, the device is used in a pipe clogged item removing and pipe cleaning method in which the device is inserted into one or more openings except one opening, used for prohibiting leakage of the compressed air from the opening, it is inserted into an end surface of the pipe with a rod-like member constituted of rubber resilient member used for prohibiting leakage of the compressed air from the opening, it is engaged with the pipe by the releasing prohibiting fitting and at the same time the rod-like member is closely brought into contact with the pipe under rotation of a nut for a bolt axially passing through it and fixed to a location requiring the passage shielding.

The present invention can provide a pipe clogged item removing and pipe cleaning machine or device, a pipe cleaning method and a compressed air leakage prohibiting member in which they can be used not only in the usual homes but also in various kinds of drain facilities in usual society, the clogged items in various kinds of pipes can be removed rapidly, simply and easily and the cleaning work can also be carried out, resulting in that the present invention may provide a substantial effect in the industry.

### BRIEF DESCRIPTION OF THE DRAWINGS

FIG. 1 is an illustrative view for showing an instrument for repairing a clogged state of a toilet stool which is one preferred embodiment of a pipe clogged item removing and pipe cleaning device in accordance with the present invention.

FIG. 2 is an illustrative view for showing a substantial part of the embodiment shown in FIG. 1.

FIG. 3 is an illustrative view for showing a substantial part in its state of use of the embodiment shown in FIG. 1.

FIG. 4 is an illustrative view for showing another preferred embodiment of a pipe clogged item removing and pipe cleaning machine or device in accordance with the present invention.

FIG. 5 is an illustrative view for showing a substantial part of a still further preferred embodiment of a pipe clogged item removing and pipe cleaning machine or device in accordance with the present invention.

FIG. 6 is an illustrative view for showing a substantial part of a still further preferred embodiment of a pipe clogged item removing and pipe cleaning machine or device in accordance with the present invention.

FIG. 7 is an illustrative view for showing its state of use of the embodiment shown in FIG. 6.

FIG. 8 is an illustrative view for showing a substantial part of another preferred embodiment of an abutting member (a water splashing prohibiting plug).

FIG. 9 is an illustrative view for showing a state of work of a pipe clogged item removing and pipe cleaning device under application of the water splashing prohibiting plug shown in FIG. 8.

FIG. 10 is an illustrative view for showing a structure of a substantial part of another preferred embodiment of the plug member used in FIG. 4.

FIG. 11 is an illustrative view for showing a pipe clogged item removing and pipe cleaning device under application of the plug member shown in FIG. 10.

FIG. 12 is an illustrative view for showing a pipe clogged item removing and pipe cleaning device under application of the plug member shown in FIG. 10.

FIG. 13 is an illustrative view for showing a state of use of a pipe clogged item removing and pipe cleaning device shown in FIG. 11 at the time of removing the clogged items in some continuous pipes.

FIG. 14 is an illustrative view for showing a preferred embodiment of a compressed air leakage prohibiting member used in FIG. 13 (a rubber tube plug).

FIG. 15 is an illustrative view for showing another preferred embodiment of a compressed air leakage prohibiting member (a rubber tube air pressure plug).

FIG. 16 is an illustrative view for showing a still further preferred embodiment of a pipe clogged item removing and pipe cleaning device in accordance with the present invention.

### DETAILED DESCRIPTION OF THE PREFERRED EMBODIMENT

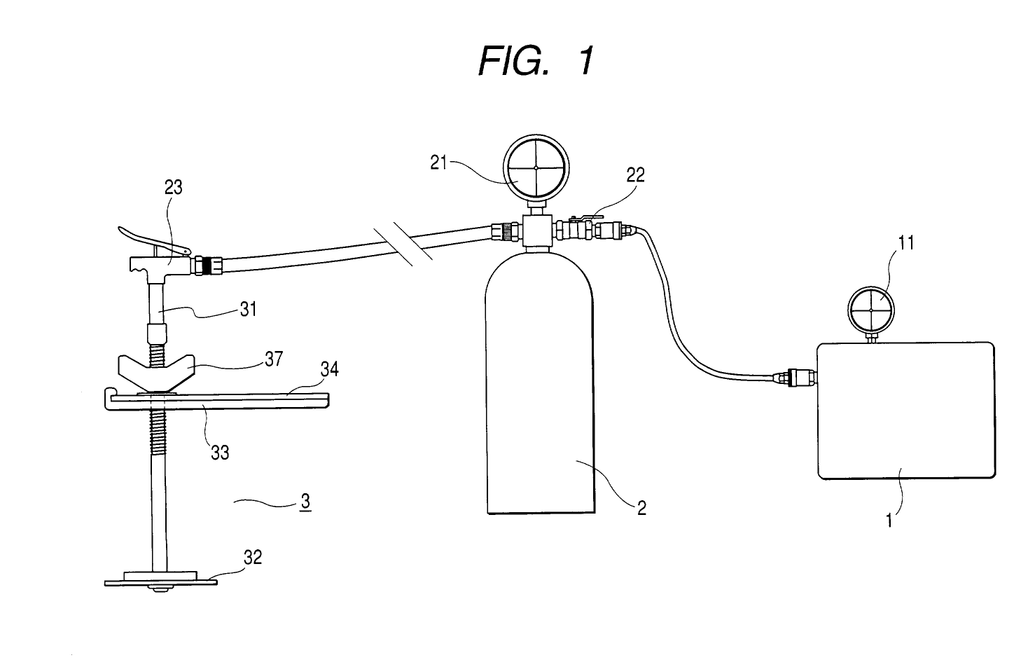

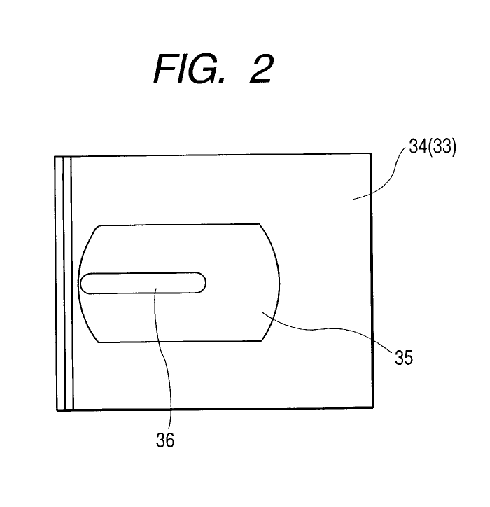

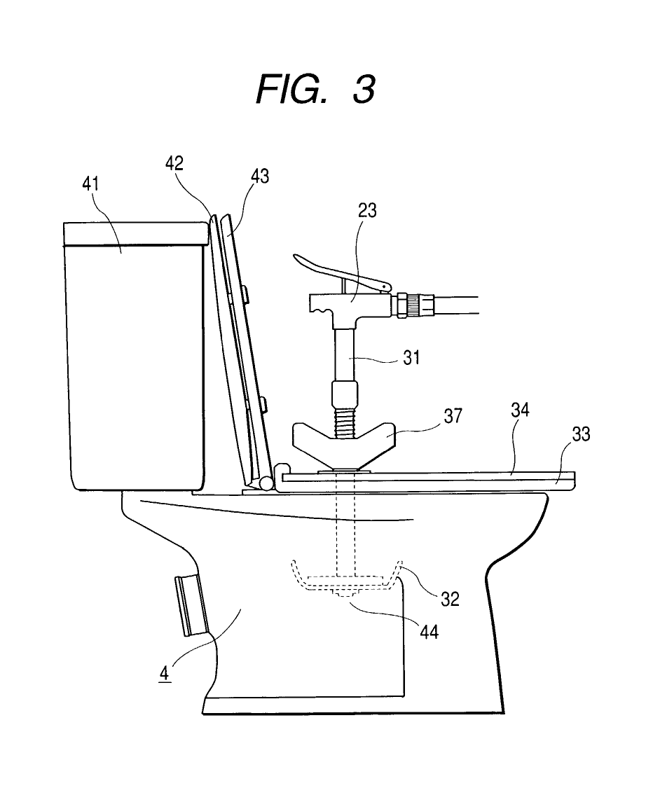

FIGS. 1 and 2 are illustrative views for showing an instrument for repairing a clogged state of a toilet stool which is one preferred embodiment of a pipe clogged item removing and pipe cleaning machine or device in accordance with the present invention, wherein FIG. 1 is an entire configuration view, FIG. 2 is an illustrative view for showing a substantial part of FIG. 1, and FIG. 3 is an illustrative view for showing its state of use. In these figures, reference numeral 1 denotes a compressor (having a volumetric capacity of 1.7 MPa, for example); 11 a pressure gauge; 2 a pressure tank (having a tank volumetric capacity of 500 cc, for example); 21 a pressure gauge; 22 a valve; 23 an opening or closing unit; and 3 an instrument for repairing clogged state of a toilet stool. Air of predetermined pressure (about 0.5 to 0.9 MPa, for example) is held in the pressure tank 2 under an operation of the compressor 1 so as to enable stored air in the pressure pump 2 to be supplied at once to the instrument 3 for repairing clogged state of a toilet stool which can be airtightly installed at a pipe where clogged state occurs.

Reference numeral 31 denotes an air-feeding pipe; 32 an abutment member for a drain pipe of a toilet stool; 33 a water splashing prohibiting member; 34 a mounting member; 35 a transparent window; 36 a slide hole; and 37 a winged screw. In FIG. 3, reference numeral 4 denotes a toilet stool of splashing type toilet; 41 a water tank for a water splashing operation; 42 a lid; 43 a stool seat; and 44 a drain port (a trap inlet port).

The splashing prohibiting member 33 is made of sponge material, for example, which is mounted on the upper surface of the toilet stool, and this is arranged below a mounting member 34 for preventing water from being splashed around it during a clogged item removing work. The mounting member 34 is constituted of transparent material such as an acrylic resin plate. The transparent window 35 is arranged at an upper part of a toilet stool drain port 44. Therefore, a mounting state of the abutting member 32 to the drain port 44 arranged at the extremity end of an air-feeding pipe 31 passed through and installed at the slide hole 36 can be observed from above, and its position can be aligned by its motion in the slide hole 36 to adjust an angle. The winged screw 37 is arranged for fixing to keep a state after adjusting an angle of the air-feeding pipe 31.

A method for using the instrument for repairing a clogged state of toilet stool assembled in this way will be described as follows.

As shown in FIG. 3, the mounting member 34 is mounted on the upper end of a toilet stool 4 having the lid 42 and the toilet seat 43 opened therein through the water splashing prohibiting member 33, the air-feeding and supplying pipe 31 is moved along the slide hole 36 in such a way that the abutting member 32 of the air-feeding and supplying pipe 31 is air-tightly abutting to the drain port 44 of the toilet stool 4 and their positional alignment at this time is set through the transparent window 35. Upon completion of adjustment of the air-feeding pipe 31 against the drain port 44, a setting of the instrument for repairing the clogged state of the toilet stool is completed after fixing by the winged screw 37.

In turn, the compressor 1 is operated under a state in which the opening or closing unit 23 is closed and the valve 22 of the pressure tank 2 is opened, and the valve 22 is being kept closed in such a way that a pressure in the pressure tank 2 may become a predetermined pressure.

Accordingly, if the opening or closing unit 23 is opened under a state in which the instrument 3 for repairing clogged item in the toilet stool is set on the toilet stool 3, compressed air in the pressure tank 2 is supplied at once into the drain port 44 of the toilet stool 4 from the extremity end of the air-feeding pipe 31 and the clogged item in the pipe is pushed out.

Since this device utilizes the compressed air, it is possible to perform the operation in a simple, easy and fast manner. In particular, a work for setting the instrument 3 for repairing a clogged state of toilet stool at the drain port 44 of the toilet stool 4 can be realized in a simple and easy manner without requiring any specific skill and further even at the time of supplying air to the instrument, there is no possibility of splashing back of water within the drain port and staining surroundings and the work can be performed efficiently and rapidly.

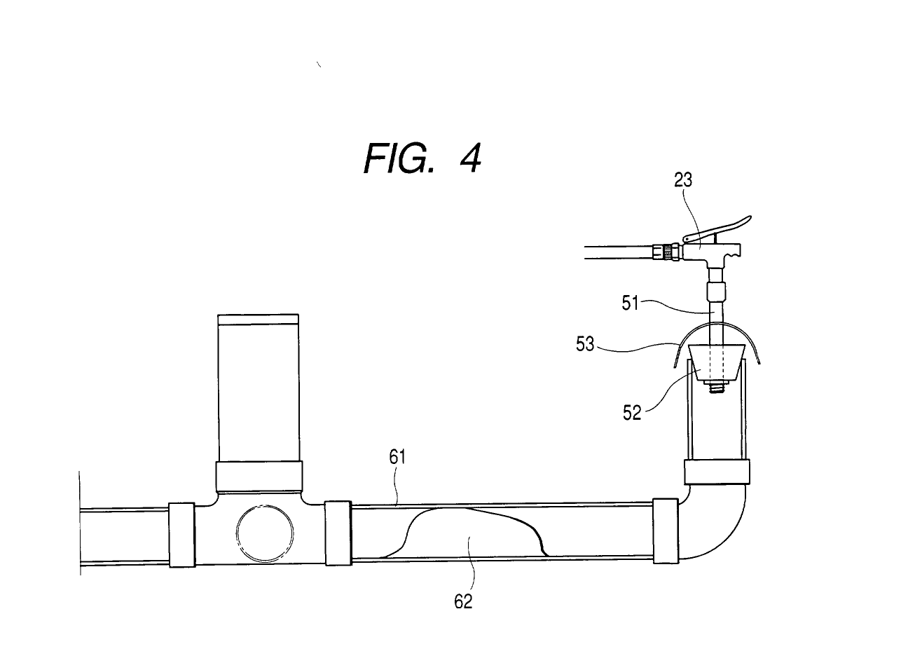

FIG. 4 is an illustrative view for showing a substantial part of another preferred embodiment of the present invention, wherein reference numeral 51 denotes an air-feeding pipe; 52 a plug member fixed at the extremity end of the air-feeding pipe 51; 61 a pipe; 62 a clogged item; and 53 a water splashing prohibiting cover positioned between the air-feeding pipe 51 and the plug member 52 to cover an end part of the pipe 61.

This example shows a case in which the present invention is directly fixed to and operated at the pipe 61 where the clogged item 62 is produced, wherein in such a case as above, the plug member 52 is fixed under a state in which the plug airtightly closes the pipe 61 at the extremity end of the air-feeding pipe 51. Further, if the water splashing prohibiting cover 53 is installed there, liquid stored in the pipe does not inject even under an unexpected situation and no trouble occurs.

Further, if a length of the air-feeding pipe 51 is selected as required, it is also possible to remove clogged item at the pipe where a narrow part is present.

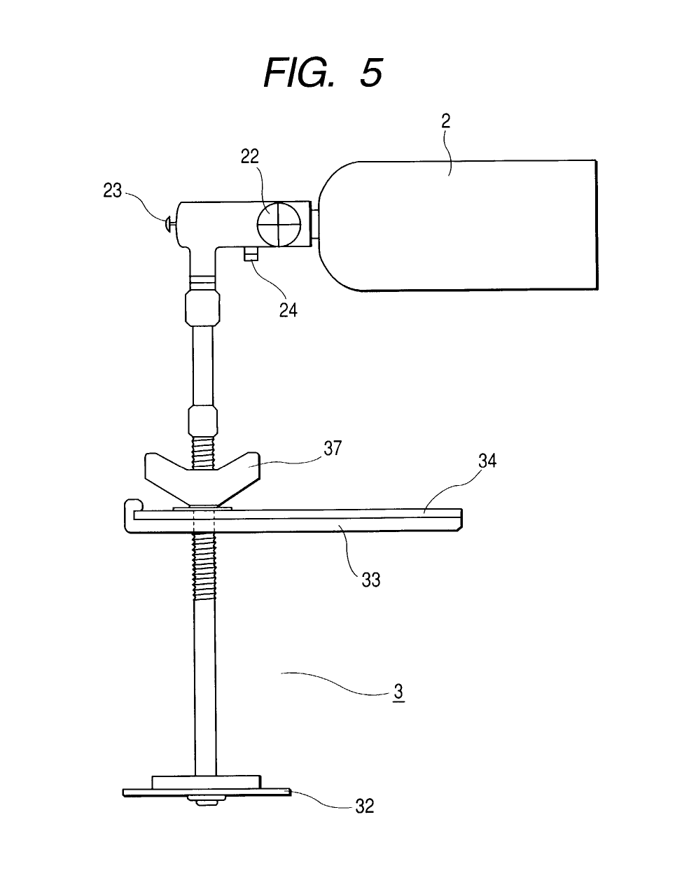

FIG. 5 is an illustrative view for showing a substantial part of another preferred embodiment of the present invention, wherein the same segments as those shown in FIGS. 1 to 4 are denoted by the same reference symbols and reference numeral 24 denotes an air supplying port (air inlet).

Points in this preferred embodiment different from those of the preferred embodiment in FIG. 1 or FIG. 4 consist in an arrangement in which the compressor acting as a device is not connected, the compressed air filled in the pressure tank 2 is supplied from another separate device, a compressor, for example, and the compressor is separated upon completion of charging of air in it.

A method for using this device will be described as follows. A method for installing the instrument 3 for repairing the clogged state in the toilet stool is similar to that of the preferred embodiment shown in FIG. 1. In the device shown in FIG. 1, after the compressed air is supplied to the pressure tank 2 by the compressor 1 at its site of application, the opening or closing unit 23 is opened to supply the compressed air contained in the pressure tank 2 to the instrument 3 for repairing the clogged state in the toilet stool. On the other hand, in the case of the device of the preferred embodiment, the compressed air is filled in the pressure tank 2 in advance by the compressor through the air supplying port 24, and upon completion of filling operation, the device is transported to its site of application under a state in which the device is separated from the compressor and then the pipe clogged item removing operation for the pipe is carried out.

Further, instead of filling the compressed air under application of the compressor, the compressed air may be charged in an air bomb or the compressed air may be filled at an air supplying stand. In addition, as the compressor, an air pump for a bicycle can be used. In this case, it is preferable that the air supplying port 24 and a valve mechanism in it are set to have the same structure as that of the air supplying port or the valve mechanism for a normal bicycle tire. With such an arrangement as above, it is possible to manufacture at low cost the component parts of the valve mechanism arranged at the air supplying port and at the same time a maintenance work for the component parts of the valve mechanism can be easily carried out. Further, in regard to the preferred embodiment of a type in which a convenient compressed air supplying source such as an air pump for a bicycle, a pressure gauge for a pressure tank may be eliminated.

Although an operation for removing the clogged items in a pipe and cleaning inside the pipe with a pressure of compressed air is the same as that of the preferred embodiment shown in FIG. 1, the device in this preferred embodiment does not require any operation for transporting a compressor, for example, to a site of application, resulting in that the device can be conveniently transported and so if the compressed air is filled in advance in the air pump, an operator can take a proper step to meet the situation as required. Further, a size of the entire device becomes small, so that the device is conveniently used at home.

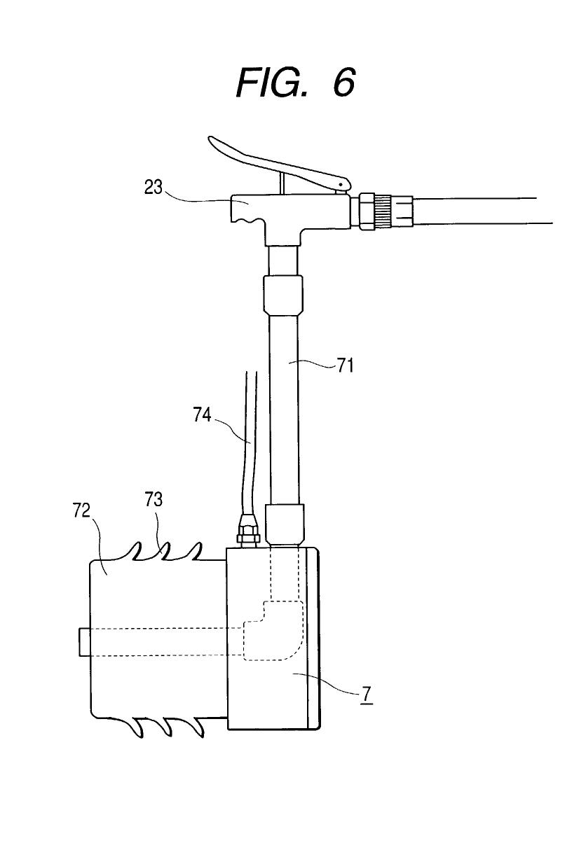

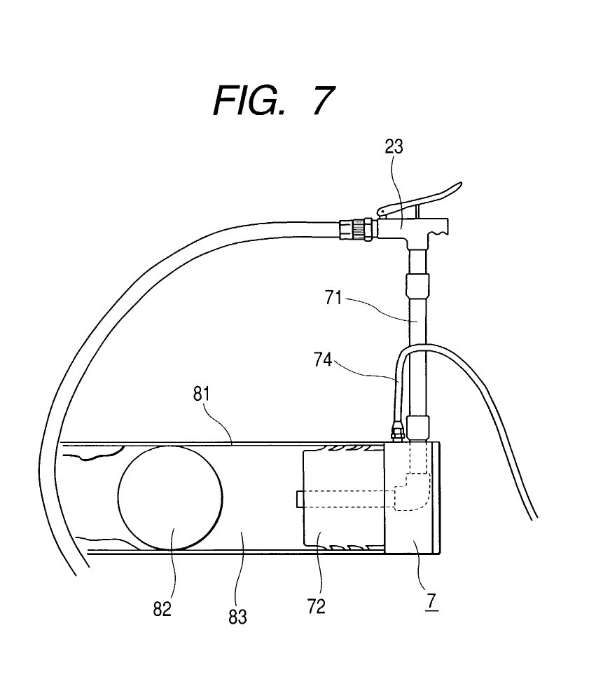

FIGS. 6 and 7 are illustrative views for showing another preferred embodiment, wherein FIG. 6 is an illustrative view for showing a structure of a substantial part and FIG. 7 is an illustrative view for showing a state of use of the substantial part. The same portions as those shown in FIGS. 1 to 5 are denoted by the same reference symbols. Reference numeral 7 denotes a seal plug device; 71 an air-feeding pipe; 72 an air bag; 73 annular protrusions arranged at the air bag 72; 74 an air supplying passage connected to the compressor 1 (refer to FIG. 1); 81 a pipe; 82 a sponge ball; and 83 water.

The pipe clogged item removing and cleaning machine of this preferred embodiment is constructed such that a fixing unit installed in a sealing manner at a pipe or the like requiring for removal of clogged items in a pipe and cleaning inside the pipe is comprised of an air-feeding pipe 71 connected to the opening or closing unit 23; the seal plug device 7 air-tightly fixed to an outer circumference of the air-feeding pipe 71, expandable or retractable with pneumatic pressure and for air-tightly fixing the air-feeding pipe 71 in a pipe 81 to be inspected through expansion by compressed air supplied through the air supplying passage 74 after being inserted into the pipe where the clogged items are present; and an air flow passage 74 in which the seal plug device 7 is operated by the compressor 1 (refer to FIG. 1).

Next, referring to FIG. 7, its state of use (a pipe cleaning state) will be described as follows. In this example, a sponge ball 82 having a substantially same diameter as that of the pipe 81 is inserted into the pipe 81 where the clogged items are present, after the water 83 is filled, the compressed air (of about 0.5 to 0.9 MPa) is supplied by the compressor 1 through the air supplying passage 74 under a state in which the seal plug device 7 is inserted, resulting in that the air bag 72 is expanded and closely brought into contact with the pipe 81. An outer circumference of the air bag 72 is provided with belt-like protrusions 73 inclined toward the inserting side, for example, to improve a close-fitness with the pipe 81.

Accordingly, the air-feeding pipe 71 air-tightly constituted by the air bag 72 is air-tightly mounted at the pipe 81. If the compressed air compressed in the pressure tank 2 (refer to FIG. 1) is supplied into the pipe 81 by the compressor 1 (refer to FIG. 1) in the same manner as that of the aforesaid preferred embodiment under this state, the sponge ball 82 is pushed by water and moves in the pipe 81, resulting in that if some clogged items are present there, the sponge ball pushes and flows away the clogged items and if the pipe wall is stained, the pipe wall can be cleaned.

Cleaning the pipe installed in an agricultural pond under application of such a method as described above enabled an intended object to be attained rapidly and easily. Accordingly, it can be expected that the clogged state in a pipeline connecting an upper pond with a lower pond of agricultural pond at each of the districts in a country which cannot accomplish substantially its original function due to an insufficient control in recent years is eliminated rapidly, simply and easily.

Next, a still further preferred embodiment of the present invention will be described as follows.

In the case of the toilet stool clogged state repairing instrument shown in FIGS. 2, 3 and 5, a plate-like member which is easily curved is used as the a butting member 32 so as to prevent leakage of the compressed air due to a deformation and close contact state when it is pushed against the drain port 44.

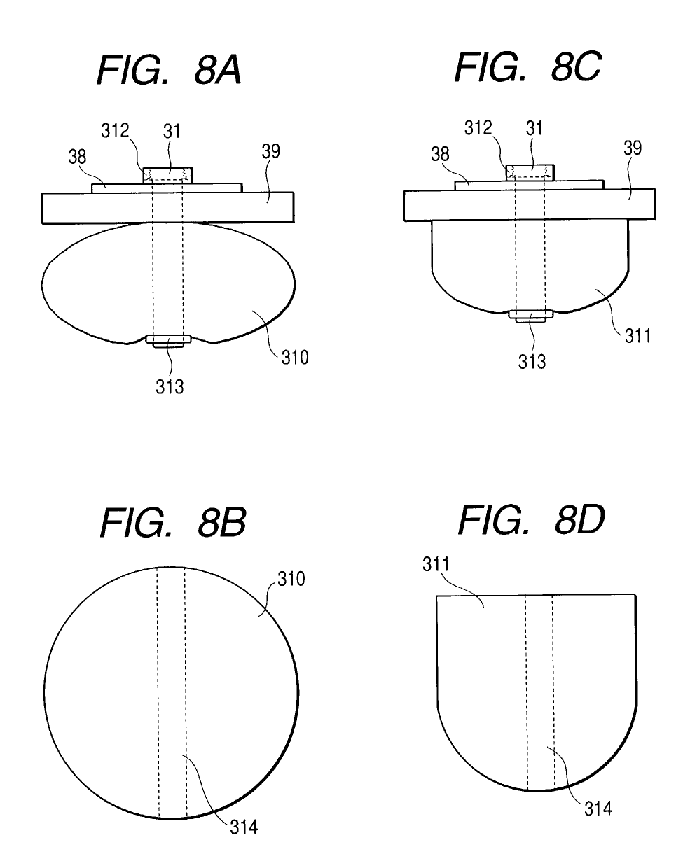

FIG. 8 (FIGS. 8A, 8B and 8C) shows another example of the abutting member (a water splashing prohibiting plug) used for attaining a similar object, or used for the pipe clogged item removing and pipe cleaning device widely used in the industry and the same portions as those shown in FIGS. 2, 3 and 5 are denoted by the same reference symbols. FIGS. 8A and 8C are sectional views for showing a substantial part under a state in which a preparation for the toilet stool clogged state repairing work is completed, for example, and FIGS. 8B, 8D show sectional views for showing the component parts before their assembling operation. In these figures, reference numeral 38 denotes a plate-like supporting member; 39 a first abutting member constituted of hard rubber sponge; 310, 311 a second abutting member constituted of a soft sponge, such as a marine sponge; and 312, 313 a nut. The second abutting members 310, 311 constituted of soft sponge are a spherical member or a column-like member having a spherical bottom surface with a radius of 10 to 17 cm of opened hole 314 of 15 mm at the center thereof, for example, as shown in FIGS. 8B, 8D, and when the abutting members are assembled at the air-feeding pipe 31 by the nuts 312, 313 together with the first abutting member 39 constituted of hard rubber sponge, as shown in FIGS. 8A, 8C, the second abutting members 310, 311 constituted of soft sponge become an elliptical member or a dome-like member as shown in FIGS. 8A, 8C.

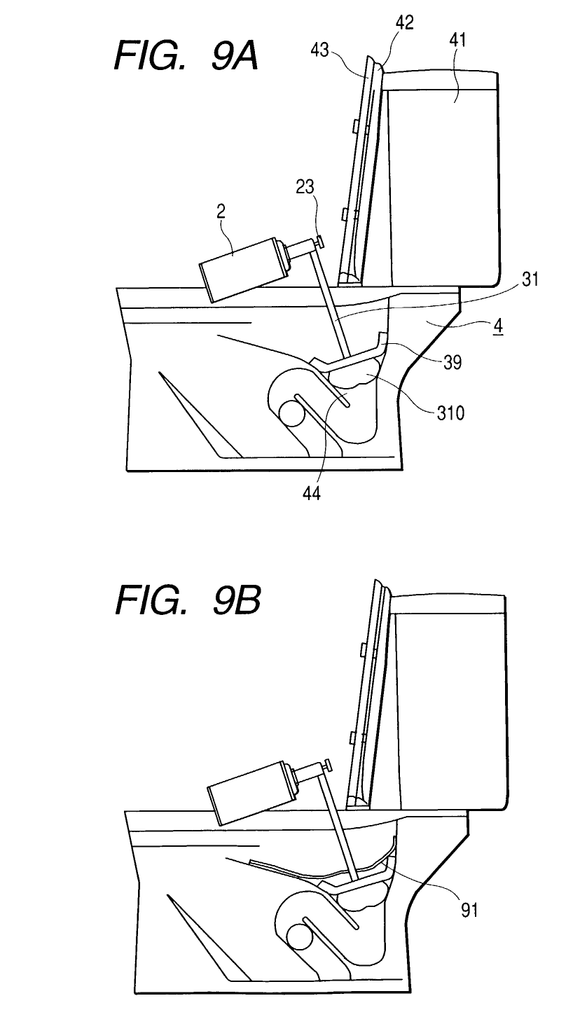

FIG. 9 (FIGS. 9A, 9B) shows a case of the preferred embodiment in which the water splashing prohibiting plug shown in FIG. 8A acting as an abutting member is applied and the pipe clogged item removing and cleaning device constituted as a portable unit is used as a toilet stool clogged state repairing instrument, wherein as the toilet stool clogged state repairing instrument is installed at the drain port 44 of the toilet stool (FIG. 9A), the instrument may produce an appropriate compressed state and the instrument can be pressed against the drain port 44 by a high resilient force, resulting in that leakage of the compressed air is reduced and the repairing work for the severe toilet stool clogged state can be carried out efficiently. Further, in the case that the water splashing occurs during the work, the toilet stool drain port 44 is covered by a newspaper sheet 91, for example, as shown in FIG. 9B, to enable the water splashing back state to be prevented and its work is facilitated.

Further, although the mounting member 34 and the winged screw 37 or the like are used for installing air-tightly the abutting member 32 at the drain port 44 of the toilet stool 4 in the preferred embodiment shown in FIGS. 3 and 5, in the case that the members shown in FIGS. 8A, 8C are used, the toilet stool clogged state repairing instrument can be air-tightly installed at the drain port 44 even when the mounting member 34 shown in FIGS. 3 and 5 is not specially arranged, resulting in that the work can be carried out in a simple and easy manner.

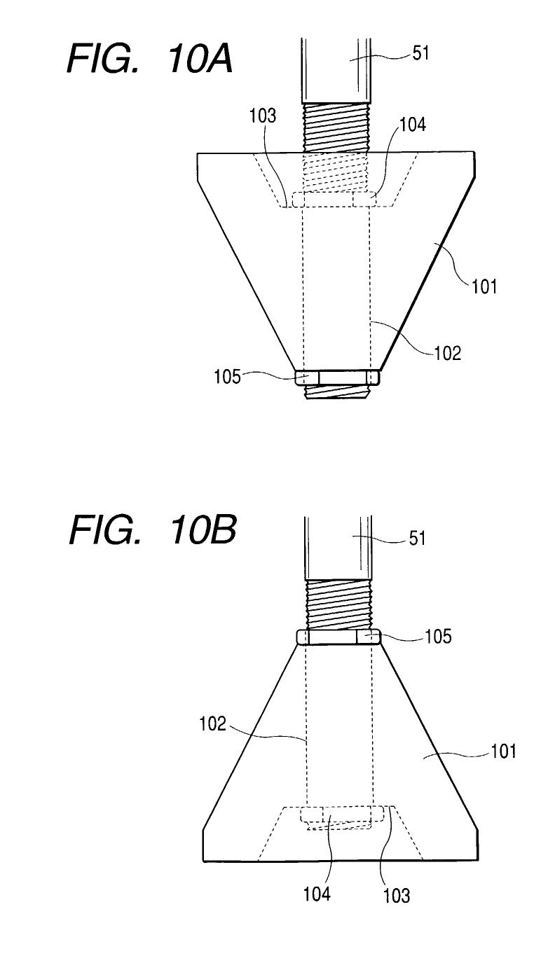

FIG. 10 (FIGS. 10A, 10B) illustrates a structure of a substantial part of another preferred embodiment of the plug member 52 used in the system shown in FIG. 4 and this is fixed to the extremity end of the air-feeding pipe 51 and used, although FIGS. 10A, 10B illustrate sectional views for showing states of use in which each of the fixing methods for the plug member 52 is different from each other.

The plug member 101 in this preferred embodiment is comprised of a rubber conical member having a through-pass hole 102 for use in fixing the air-feeding pipe 51 at the central part thereof and having a notch 103 at its bottom surface side with a large circle, and the plug is constructed to be fixed to the opening part at the extremity end of the air-feeding pipe 51 by the nuts 104, 105.

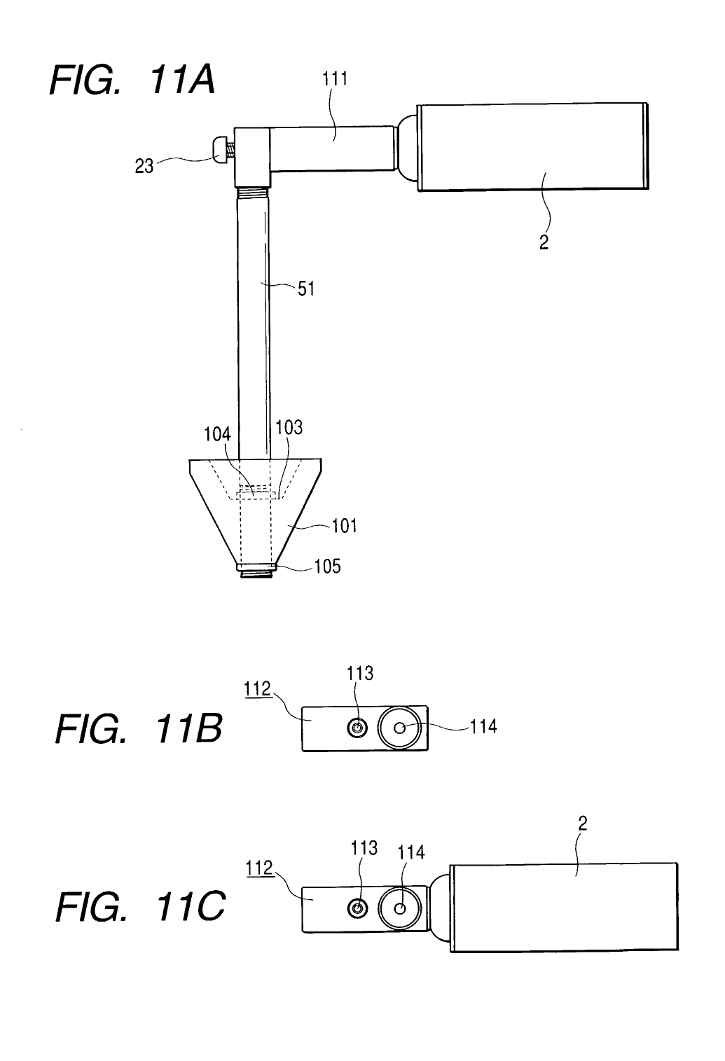

FIG. 11 (FIGS. 11A, 11B and 11C) shows the pipe clogged item removing and pipe cleaning device having the plug member 102 fixed at the extremity end of the air-feeding pipe 51 so as to become the state shown in FIG. 10A, and the same portions as those shown in FIGS. 5 and 9 are denoted by the same reference symbols. Reference numeral 111 denotes a fixing segment for a can 2 (0.5 to 0.9 Mps) and the can 2 can be removed. Accordingly, in the case that the can 2 becomes vacant, the vacant can 2 is removed from the fixing segment 111 and replaced with a new one. FIGS. 11B, 11C illustrate the air-feeding device for use in filling the compressed air into the vacant can 2 and its state of use, wherein the air-feeding device 112 is provided with an air valve 113 and a pressure gauge 114, the compressed air is filled in the used can 2 under application of the air-feeding device 112, for example, by a compressor through the air-feeding device 112 to enable the tank 2 to be applied as a spare tank. This device may be a so-called portable type and otherwise, or it may be disposable. In addition, since this device is of a so-called portable type, this device can be used at a usual home in a convenient and easy manner.

Additionally, if a street elbow is inserted between the air-feeding pipe 51 and the plug member 101, the plug member 101 can be set perpendicular to the air-feeding pipe 51, so that a pipe clogged item in a pipe for connecting a manhole or an eave trough communicating with the manhole can be removed at the manhole. When the device is installed in the manhole, an abutting wooden material or the like is inserted and fixed to prevent it from being moved backward during the work and can be used.

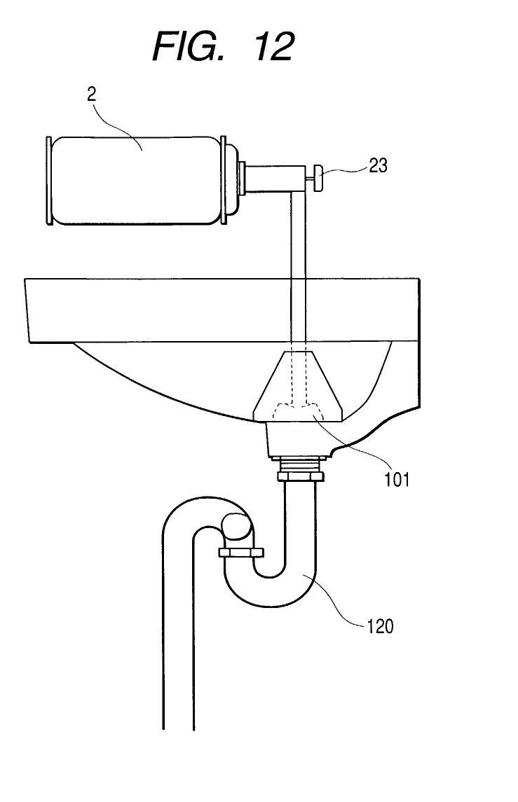

FIG. 12 illustrates an example in the case that the device is used under a state shown in FIG. 10B, wherein it shows a state of use at the time of removing the clogged item in a hop-up type trap 120. That is, this system has an effect that a different cleaning object can be accomplished only through a changing of a fixing direction of the plug member 101 to the air-feeding pipe 51.

In the case that the pipe clogged item removing and pipe cleaning device constructed as described above is required, there occurs a possibility that a plurality of toilet stools or the like are connected in general to either a main pipe or a pipe subsequent to the main pipe even in the toilet stool water pipe, for example, and in the water pipe having a plurality of openings communicating to each other, even if the compressed air is supplied through one opening of the pipe, for example, when a clogged item is produced at either the main pipe or the pipe subsequent to the main pipe, a pressure of the compressed air flows of the other pipe communicating with it, so that a pressure can be applied to the clogged item.

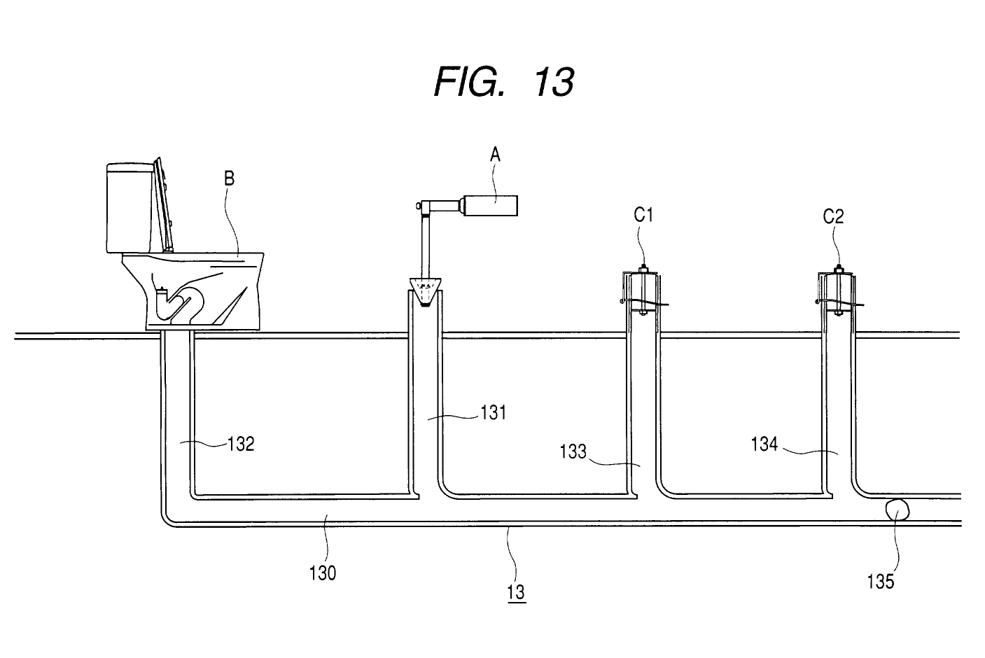

FIG. 13 illustrates a removing operation for some clogged items in some continuous connected pipes as described above, wherein the water drain system 13 illustrated in this figure shows a state that four drain pipes 131, 132, 133 and 134 are connected to the main drainpipe 130, for example, a toilet stool is connected to the drain pipe 131, and the remaining drain pipes 132, 133 and 134 are opened. In the case that a clogged item 135 is produced in the main pipe 130 in the drain system 13, even if the compressed air is supplied from the drain pipe 131, the compressed air is released from the drain pipes 132, 133 and 134, so that the object cannot be accomplished. Due to this fact, it is necessary that a toilet stool B connected to the drain pipe 132 and each of the openings C1, C2 of the drain pipes 133, 134 are kept closed, resulting in that as shown in the figure, the removing operation is performed at the opening A under a state in which the toilet stool B, the openings C1 and C2 are airtightly closed.

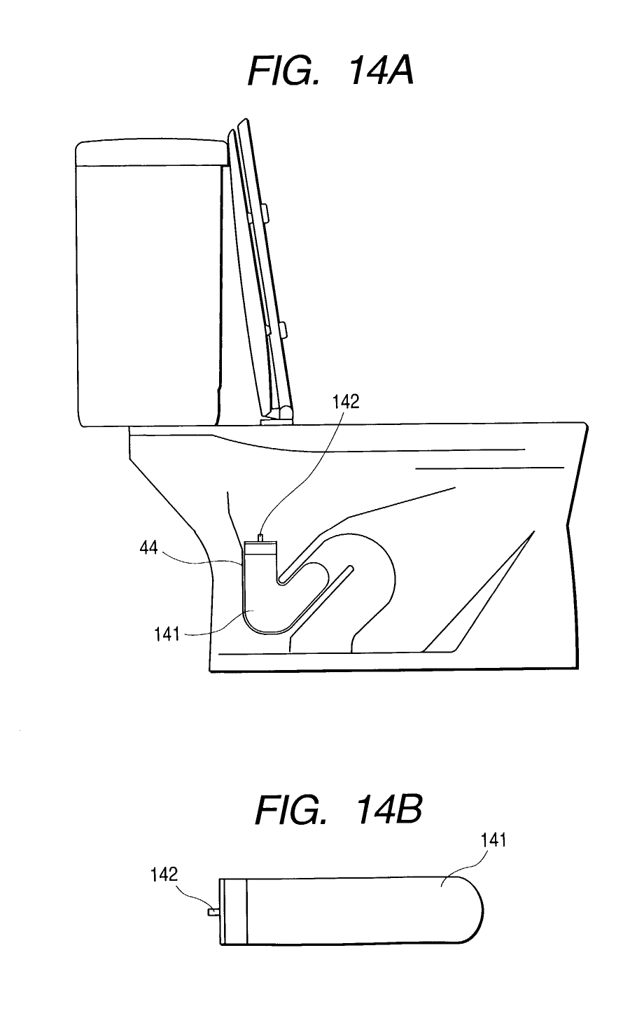

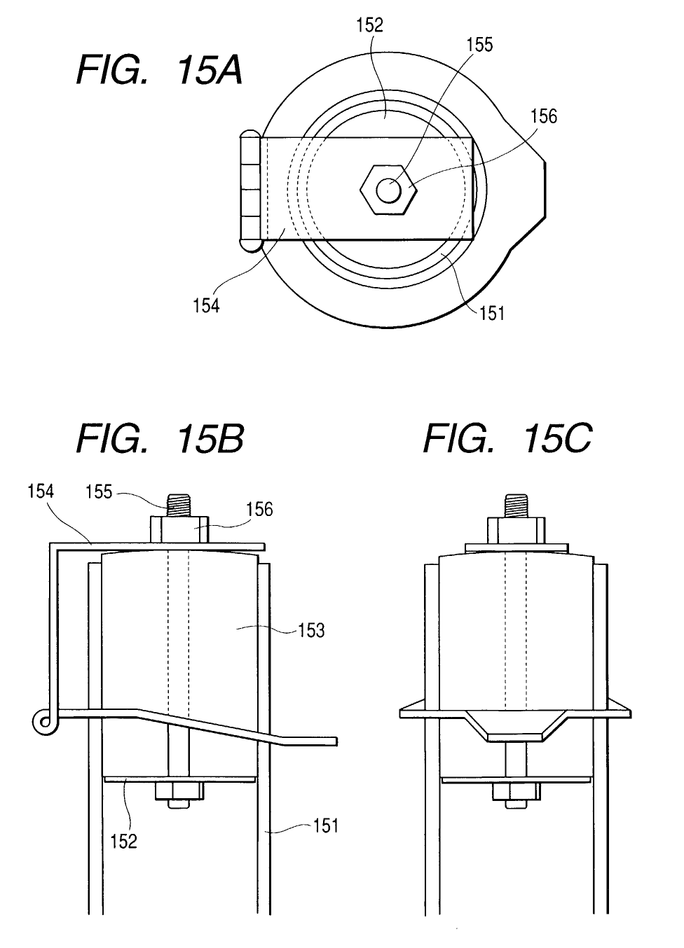

That is, in such a case as described above, it is necessary that one or more openings except one opening communicating with the main pipe is airtightly closed under a state in which water is filled therein. FIGS. 14 and 15 illustrate a structure of a compressed air leakage prohibiting member used under such a case as described above.

FIG. 14 (FIGS. 14A, 14B) illustrates a rubber tube plug which is used at a toilet stool, wherein the same portions as those shown in FIG. 3 are denoted by the same reference symbols. FIG. 14A is an illustrative view for showing a state of use and FIG. 14B is an illustrative view for showing its structure. Reference numeral 141 denotes a rod-like rubber tube which is provided with an air valve 142 acting as a compressed air feeding port. When this device is used, after the rod-like rubber tube 141 kept under a state where the compressed air is not filled as shown in FIG. 14A, for example, is inserted into the drain port 44 of the toilet stool, the compressed air is fed through the air valve 142. When the air enters, the rubber tube 141 bulges out to be deformed into such a shape as one corresponding to a shape of the drain port 44 of the toilet stool, resulting in that it is possible to shield the opening to prevent the compressed air from being flowed out and lost.

FIG. 15 (FIGS. 15A, 15B and 15C) illustrates a compressed air leakage prohibiting member (a rubber air pressure plug) which is used at the terminal end of a pipe, wherein FIGS. 15B and 15C are side views seen from a direction where they may form a right angle to each other and FIG. 15A is a top plan view of FIG. 15B. In these figures, reference numeral 152 denotes a holding plate; 153 a rubber plug; and 154 a releasing prohibiting fitting, and these members are integrally assembled into a structure by a nut 156 arranged at a free end of a bolt 155 passing through a center of the structure.

When the device is used, the rubber plug 152 is inserted into the terminal end of the pipe 151, the releasing prohibiting fitting 154 is engaged with an outer wall of the pipe 151 and fastened with the nut 156, resulting in that the rubber plug 152 is bulged out toward a pipe wall of the pipe 151 and airtightly adhered to the pipe wall.

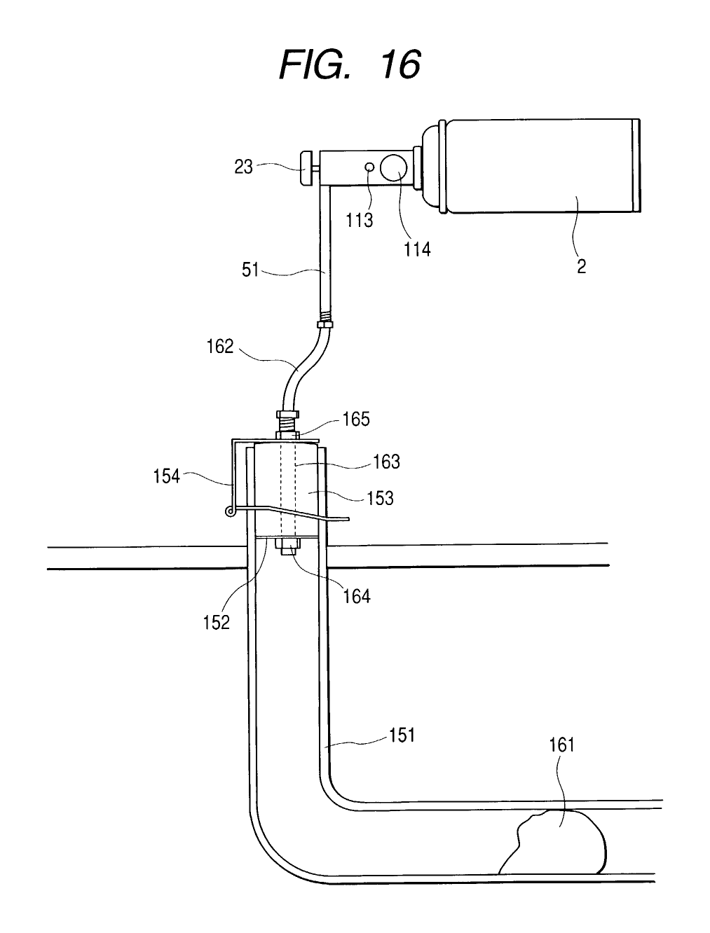

In addition, it is also possible to fix the pipe clogged item removing and cleaning device to the opening of the pipe by applying a technology for prohibiting leakage of the compressed air with the compressed air leakage prohibiting member shown in FIG. 15. FIG. 16 is an illustrative view for showing a state of use of the pipe clogged item removing and cleaning device having such a structure as above, wherein the same portions as those shown in FIGS. 11 and 15 or the like are denoted by the same reference symbols. In these figures, reference numeral 151 denotes a pipe; 161 a clogged item; 152 a holding plate; 153 a rubber plug; 154 a removing prohibiting fitting; 162, 163 air feeding pipes connected in sequence to the air feeding pipe 51, wherein the air feeding pipe 163 passes through the rubber plug 153 and is opened into the water filled in the pipe 151. The inside part of the air feeding pipe 163 in the pipe 151 is fixed with a nut 164, a nut 165 is threadably fixed to the air feeding pipe 163 at the air feeding pipe 162, the nut 165 is fastened to cause the rubber plug 153 to be compressed, closely brought into contact against the pipe 153 to prevent the leakage of the compressed air.

Then, the pipe clogged item removing and pipe cleaning device can be fixed to the pipe in this way, the opening or closing unit 23 can be opened and the compressed air in the pressure tank 2 can be supplied from the air feeding pipe 51 to the pipe 151. Although this device requires a certain fixing work before its operation, the work can be positively carried out.

In this preferred embodiment, although the device having the air valve 113 and the pressure gauge 114 between the air tank 2 and the opening or closing unit 23 has been illustrated, there occurs one case in general in which the air valve 113 and the pressure gauge 114 are installed or the other case in which they are not installed in response to a size of the device and its application or the like.

In the aforesaid preferred embodiments, although the examples have been described in which clogged items in a flush toilet stool and in a pipe for an agricultural pond are removed, it is of course apparent that the device can be similarly utilized in a facility having various kinds of drain units normally installed in an entire society as its scope of application. That is, keeping a daily lifetime at a sink, a wash basin, a toilet, a bath room and the like in usual homes and condominiums, maintaining and managing works for various kinds of drain facilities essential for managing and maintenance of various kinds of institutions constituting other social structures can be performed rapidly, safely and positively.

What is claimed is:

1. A pipe clogged item removing and pipe cleaning device comprising:
a fixing member air-tightly installed at a pipe or the like requiring a removal of clogged item and cleaning inside of it;
an air feeding pipe for supplying air instantly through the fixing member; and
a pressure tank connected to the air feeding pipe through an opening or closing unit and for supplying the compressed air.

2. A pipe clogged item removing and pipe cleaning device according to claim 1, wherein the pressure tank has an air feeding port.

3. A pipe clogged item removing and pipe cleaning device according to claim 1, wherein the pressure tank has an air feeding port and a pressure gauge.

4. A pipe clogged item removing and pipe cleaning device according to claim 1, claim 2 or claim 3,
wherein the fixing instrument has a first abutting member constituted of a plate-like member of hard rubber sponge and a second abutting member constituted of soft spherical or its similar shaped sponge compression member fixed to the plate-like supporting member.

5. A pipe clogged item removing and pipe cleaning device according to claim 1 or claim 3,
wherein the fixing instrument is of a rod-like member constituted of rubber-like resilient material, is inserted into an end surface of the pipe, engaged with the pipe by a releasing prohibiting fitting and at the same time the rod-like member is closely brought into contact with the pipe through rotation of a nut threadably fixed to the air feeding pipe axially passing therethrough.

6. A compressed air leakage prohibiting member used in a pipe clogged item removal and pipe cleaning method, wherein in the case that the pipe or the like requiring removal of the clogged item and cleaning inside the pipe has a plurality of openings communicating to each other, the device is inserted into one or more openings except one opening, used for prohibiting leakage of the compressed air from the opening, it is inserted into an end surface of the pipe with a rod-like member constituted of rubber resilient member, it is engaged with the pipe by the releasing prohibiting fitting and at the same time the rod-like member is closely brought into contact with the pipe or the like under rotation of a nut for a bolt axially passing through it, and fixed to a location requiring the passage shielding to shield the location.
